(19) United States
(12) Patent Application Publication
(10) Pub. No.: US 2026/0342635 A1
(43) Pub. Date: Oct. 29, 2026

(54) DEVICE AND METHOD FOR TRANSMITTING AND RECEIVING SIGNAL IN WIRELESS COMMUNICATION SYSTEM

(71) Applicant: LG ELECTRONICS INC., Seoul (KR)

(72) Inventors: Kijun JEON, Seoul (KR); Taehyun LEE, Seoul (KR); Sangrim LEE, Seoul (KR); Ikjoo JUNG, Seoul (KR)

(73) Assignee: LG ELECTRONICS INC., Seoul (KR)

(21) Appl. No.: 19/104,119

(22) PCT Filed: Aug. 18, 2022
(86) PCT No.: PCT/KR2022/012335

§ 371 Date: Feb. 14, 2025

(51) Int. Cl. H04L 27/26; H04W 56/00

(52) U.S. Cl. CPC H04L 27/2656; H04W 56/001

(57) ABSTRACT

The present disclosure may provide a method for operating a first device in a wireless communication system. The method may include receiving a synchronization signal from a second device, performing a synchronization procedure with the second device based on the synchronization signal, receiving control information from the second device, generating a codeword by performing channel coding for a bit-set based on the control information, and transmitting the codeword to the second device. Herein, the bit-set may correspond to a semantic source coded feature vector for performing semantic communication, and the channel coding may be performed based on importance of partial bit-sets included in the bit-set.

### CROSS-REFERENCE TO RELATED APPLICATION(S)

This application is the National Stage filing under 35 U.S.C. 371 of International Application No. PCT/KR2022/012335, filed on Aug. 18, 2022, the contents of which is hereby incorporated by reference herein in its entirety.

### TECHNICAL FIELD

The present disclosure relates to a wireless communication system, and more particularly, to a device and method for transmitting and receiving a signal in a wireless communication system.

Specifically, the present disclosure may provide a method and apparatus for performing semantic source coding of a signal to be transmitted and received in semantic communication.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (mMTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to an apparatus and method for transmitting and receiving a signal in a wireless communication system.

The present disclosure may provide an apparatus and method for performing channel coding for a semantic encoded feature vector in a wireless communication system.

The present disclosure may provide an apparatus and method for selecting importance of a feature vector in a wireless communication system.

The present disclosure may provide an apparatus and method for performing channel coding according to importance of a feature vector in a wireless communication system.

The present disclosure may provide an apparatus and method for decoding a codeword according to importance of a feature vector in a wireless communication system.

The present disclosure may provide an apparatus and method for performing retransmission according to importance of a feature vector in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method for operating a first device in a wireless communication system may include receiving a synchronization signal from a second device, performing a synchronization procedure with the second device based on the synchronization signal, receiving control information from the second device, generating a codeword by performing channel coding for a bit-set based on the control information, and transmitting the codeword to the second device.

As an example of the present disclosure, the generating of the codeword may include generating a plurality of partial codewords by using code block segmentation.

As an example of the present disclosure, retransmitting at least one partial codeword based on importance of the bit-set and a feedback result may further be included.

As an example of the present disclosure, a method for operating a second device in a wireless communication system may transmitting a synchronization signal to a first device, performing a synchronization procedure with the first device, transmitting control information to the first device, and receiving a codeword generated by channel coding that is performed for a bit-set based on the control information.

As an example of the present disclosure, a first device in a wireless communication system may include a transceiver and a processor coupled with the transceiver, and the processor may be configured to receive a synchronization signal from a second device, to perform a synchronization procedure with the second device based on the synchronization signal, to receive control information from the second device, to generate a codeword by performing channel coding for a bit-set based on the control information, and to transmit the codeword to the second device.

As an example of the present disclosure, a second device may include a transceiver and a processor coupled with the transceiver, and the processor may be configured to transmit a synchronization signal to a first device, to perform a synchronization procedure with the first device, to transmit control information to the first device, and to receive a codeword generated by channel coding that is performed for a bit-set based on the control information.

As an example of the present disclosure, a first device may include at least one memory and at least one processor functionally coupled with the at one memory, and the processor may be configured to receive a synchronization signal from a second device, to perform a synchronization procedure with the second device based on the synchronization signal, to receive control information from the second device, to generate a codeword by performing channel coding for a bit-set based on the control information, and to transmit the codeword to the second device.

As an example of the present disclosure, a non-transitory computer-readable medium storing at least one instruction may include the at least one instruction that is executable by a processor, and the at least one instruction may be configured to receive a synchronization signal from a second device, to perform a synchronization procedure with the second device based on the synchronization signal, to receive control information from the second device, to generate a codeword by performing channel coding for a bit-set based on the control information, and to transmit the codeword to the second device.

The following embodiments may commonly apply.

As an example of the present disclosure, the bit-set may correspond to a semantic source coded feature vector for performing semantic communication, and the channel coding may be performed based on importance of partial bit-sets included in the bit-set.

As an example of the present disclosure, the channel coding may be performed by using channel coding codes different from each other according to the importance of the partial bit-sets.

As an example of the present disclosure, the importance of the partial bit-sets may be determined according to positions of bits on a resource.

As an example of the present disclosure, the importance of the partial bit-sets may be determined, in the second device, based on a result of a task operation that is performed by using the bit-set that is channel-coded not based on the importance of the partial bit-sets and is transmitted.

As an example of the present disclosure, the result of the task operation may include task operation accuracy information according to whether or not there is an error in each of the partial bit-sets.

As an example of the present disclosure, the importance of the partial bit-sets may be determined based on an order of layers corresponding to the partial bit-sets.

As an example of the present disclosure, the control information may include a first indicator for indicating an importance selection method and a second indicator for indicating importance of each bit according to the importance selection method.

As an example of the present disclosure, the feedback result may be a response to a result of decoding that the second device performs for the codeword, and the response may be determined according to each of the partial codewords.

As an example of the present disclosure, the feedback result may be determined based on a syndrome check.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, it is possible to improve efficiency of resource utilization by performing channel coding and retransmission for a semantic encoded feature vector according to importance in a wireless communication system.

According to the present disclosure, it is possible to improve task performance at a receiver by performing channel coding and retransmission according to importance of a feature vector in a wireless communication system.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure.

### BRIEF DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a hand-held device applicable to the present disclosure.

FIG. 5 is a view showing an example of a car or an autonomous driving car applicable to the present disclosure.

FIG. 6 is a view showing an example of artificial intelligence (AI) device applicable to the present disclosure.

FIG. 7 is a view showing a method of processing a transmitted signal applicable to the present disclosure.

FIG. 8 is a view showing an example of a communication structure providable in a 6th generation (6G) system applicable to the present disclosure.

FIG. 9 is a view showing an electromagnetic spectrum applicable to the present disclosure.

FIG. 10 is a view showing a THz communication method applicable to the present disclosure.

FIG. 11A illustrates examples of existing communication systems according to an embodiment of the present disclosure.

FIG. 11B illustrates examples of semantic communication systems according to an embodiment of the present disclosure.

FIG. 12 illustrates an example of a feature vector according to an embodiment of the present disclosure.

FIG. 13 illustrates an example of bit selection according to an embodiment of the present disclosure.

FIG. 14 illustrates an example of feature selection according to an embodiment of the present disclosure.

FIG. 15 illustrates an example of subtask selection according to an embodiment of the present disclosure.

FIG. 16 illustrates an example of a channel coding procedure of a device according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

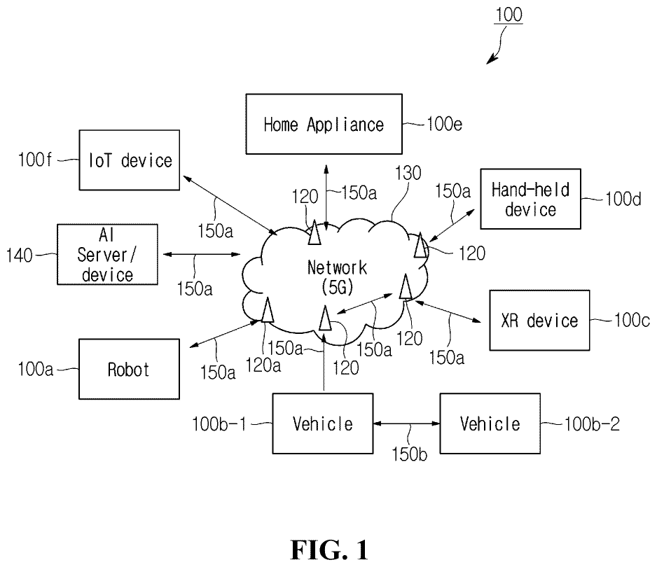

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

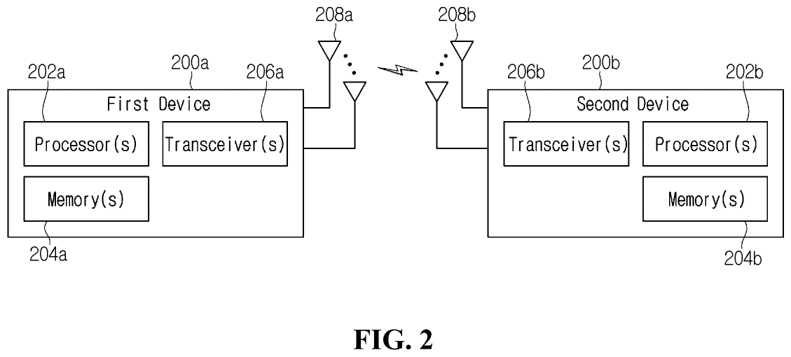

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

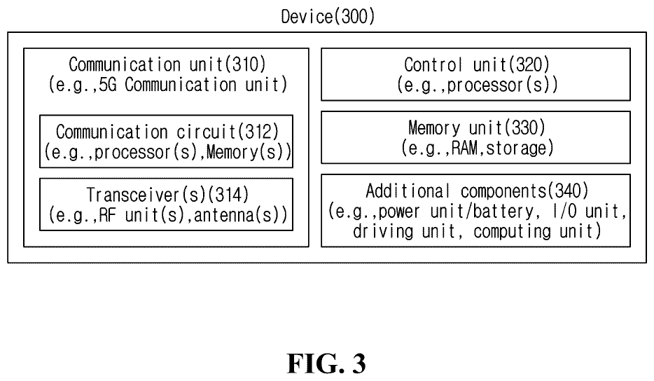

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

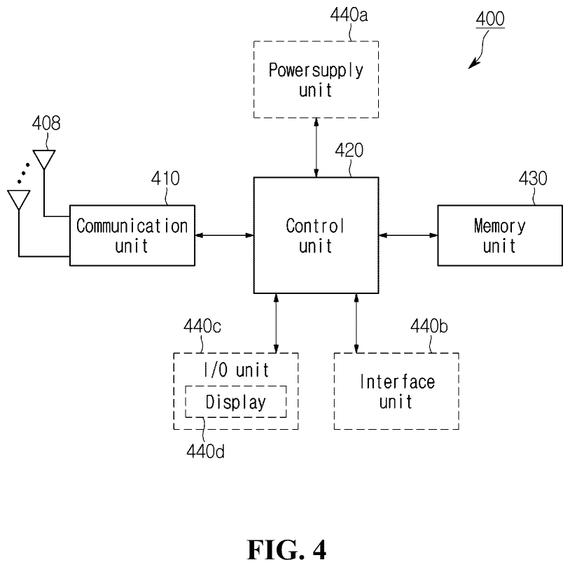

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

For example, in case of data communication, the input/output unit 440c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440c in various forms (e.g., text, voice, image, video and haptic).

### Type of Wireless Device Applicable to the Present Disclosure

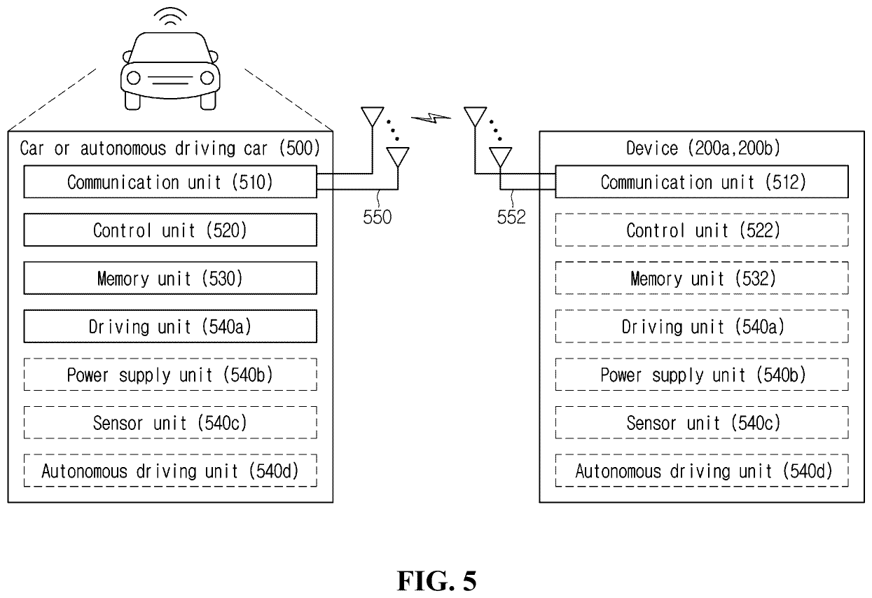

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

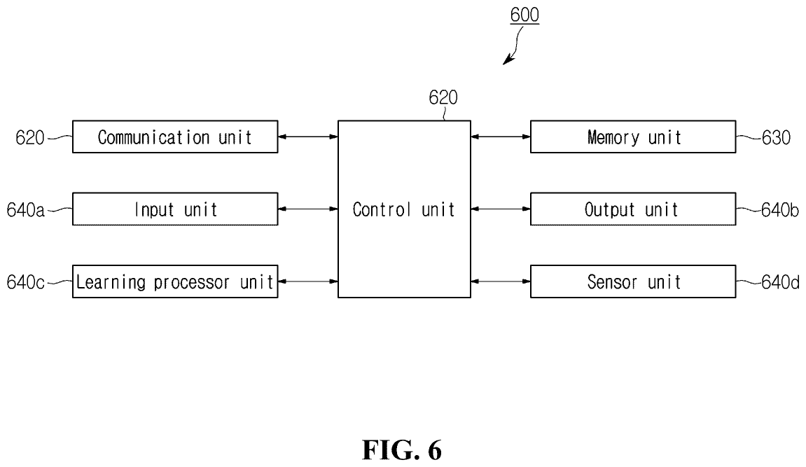

FIG. 6 is a view showing an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 650c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

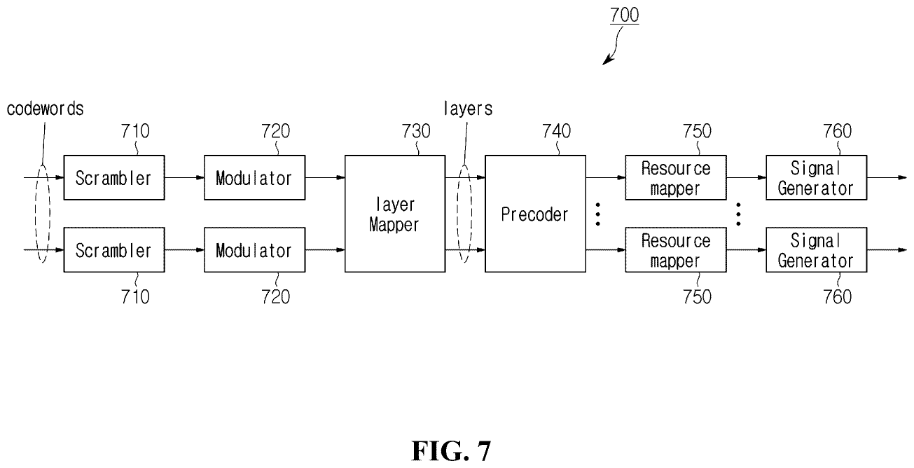

FIG. 7 is a view showing a method of processing a transmitted signal applicable to the present disclosure. For example, the transmitted signal may be processed by a signal processing circuit. At this time, a signal processing circuit 700 may include a scrambler 710, a modulator 720, a layer mapper 730, a precoder 740, a resource mapper 750, and a signal generator 760. At this time, for example, the operation/function of FIG. 7 may be performed by the processors 202a and 202b and/or the transceiver 206a and 206b of FIG. 2. In addition, for example, the hardware element of FIG. 7 may be implemented in the processors 202a and 202b of FIG. 2 and/or the transceivers 206a and 206b of FIG. 2. For example, blocks 710 to 760 may be implemented in the processors 202a and 202b of FIG. 2. In addition, blocks 710 to 750 may be implemented in the processors 202a and 202b of FIG. 2 and a block 760 may be implemented in the transceivers 206a and 206b of FIG. 2, without being limited to the above-described embodiments.

A codeword may be converted into a radio signal through the signal processing circuit 700 of FIG. 7. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH). Specifically, the codeword may be converted into a bit sequence scrambled by the scrambler 710. The scramble sequence used for scramble is generated based in an initial value and the initial value may include ID information of a wireless device, etc. The scrambled bit sequence may be modulated into a modulated symbol sequence by the modulator 720. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 730. Modulation symbols of each transport layer may be mapped to corresponding antenna port(s) by the precoder 740 (precoding). The output z of the precoder 740 may be obtained by multiplying the output y of the layer mapper 730 by an N*M precoding matrix W. Here, N may be the number of antenna ports and M may be the number of transport layers. Here, the precoder 740 may perform precoding after transform precoding (e.g., discrete Fourier transform (DFT)) for complex modulation symbols. In addition, the precoder 740 may perform precoding without performing transform precoding.

The resource mapper 750 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 760 may generate a radio signal from the mapped modulation symbols, and the generated radio signal may be transmitted to another device through each antenna. To this end, the signal generator 760 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 710 to 760 of FIG. 7. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

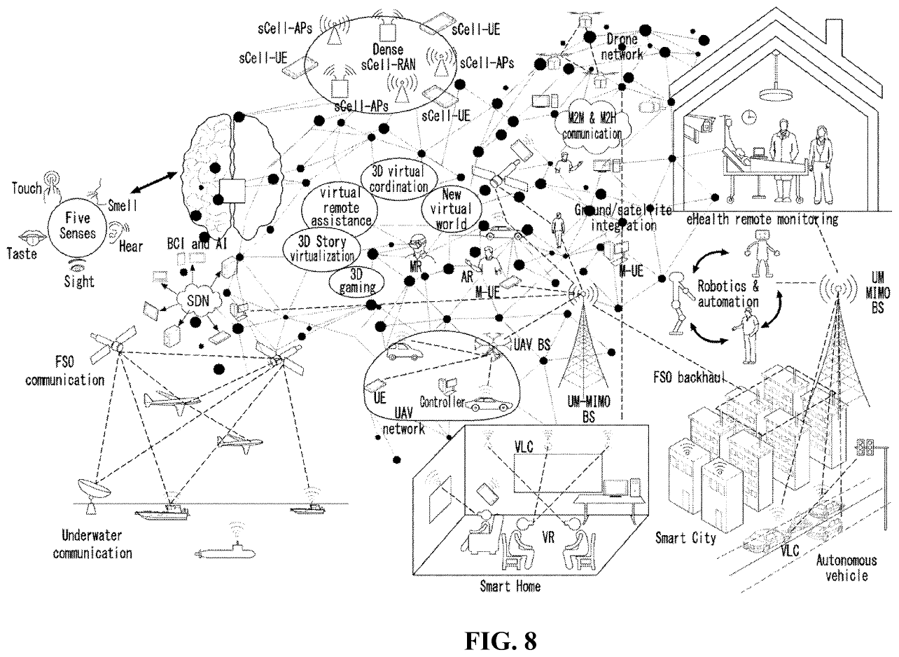

FIG. 8 is a view showing an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-THz communication with wide bandwidth and applying advanced massive MIMO technology.

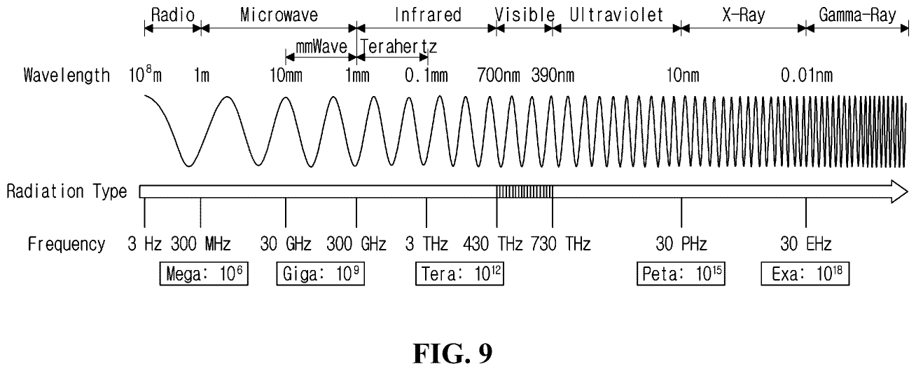

FIG. 9 is a view showing an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated by the high directional antenna reduces interference. The small wavelength of a THz signal allows a larger number of antenna elements to be integrated with a device and BS operating in this band. Therefore, an advanced adaptive arrangement technology capable of overcoming a range limitation may be used.

### THz Wireless Communication

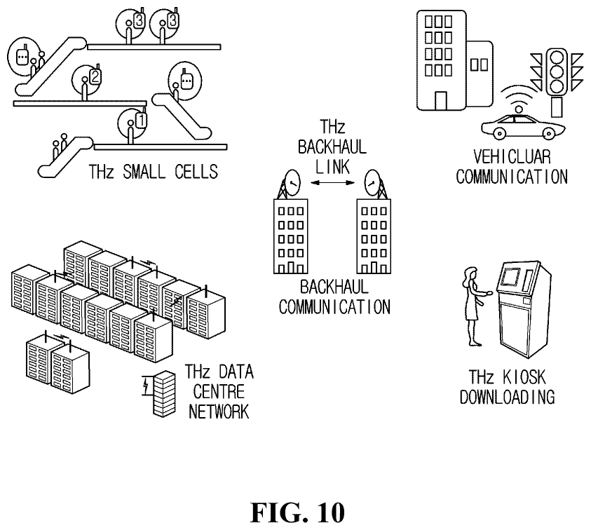

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### Specific Embodiments of the Present Disclosure

Based on Shannon's philosophy, the existing communication systems have been developed through a metric focusing on data rates such as throughput, frequency and energy efficiency, and latency speed. That is, studies on the existing communication systems have been actively performed to achieve successful transmission and reception of symbols. However, as the existing communication systems do not consider a transmission strategy, data meaning and relationship together, an unnecessary resource may be used to transmit less related-information, and there may be a limitation in performing 6G communication that requires massive data transmission and reception.

The ultimate purpose of communication is to exchange the ‘meaning’ of information. In this regard, the meaning of transmitted data, which has not been considered, is deemed to have an important role in the next generation communication, and semantic communication based on the concept of ‘meaning conveyance’ emerges as one paradigm for the next-generation wireless communication.

Semantic communication refers to a communication system that uses common information (e.g., background knowledge) shared by a transmitted and a receiver to efficiently transmit and receive semantic information. Semantic communication is a high-efficiency communication method considering the meaning of transmitted data and is capable of transmitting and processing data at the speed of data traffic that increases exponentially. Furthermore, it is expected that by the year 2029, a lot of devices employing many artificial intelligence (AI) technologies will be developed along with the commercialization of 6G communication, and thus semantic communication will be used to convey meaning accurately and quickly in communication among AI devices and between AI devices and humans.

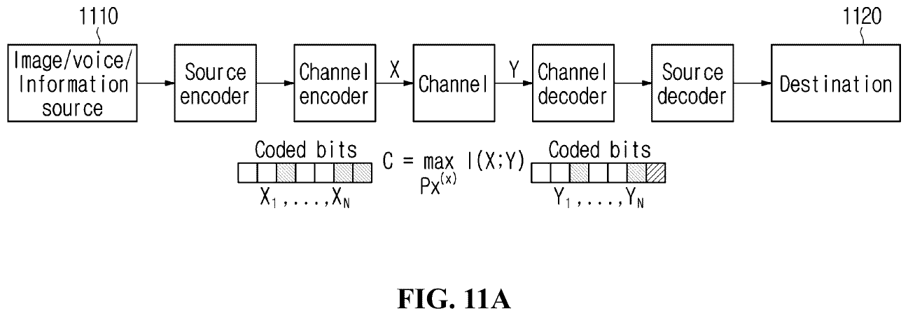

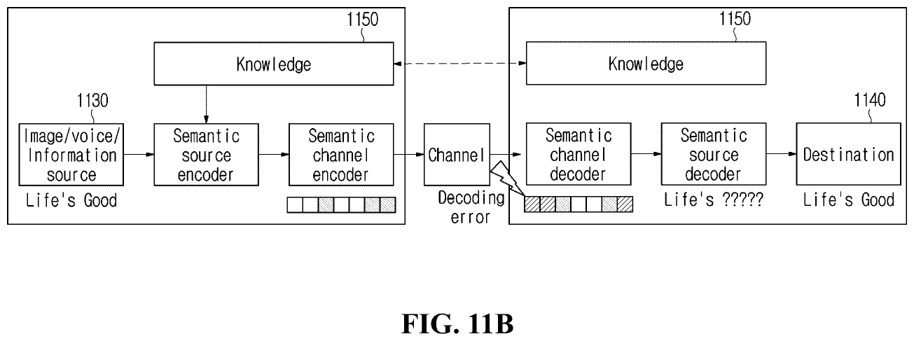

FIGS. 11A and 11B illustrate examples of communication systems according to an embodiment of the present disclosure. Referring to FIG. 11A, the existing communication focuses on decoding by a destination 1120 an encoded signal received from a source 1110 into an original signal without error. On the other hand, referring to FIG. 11B, like human communication that exchanges information through the ‘meaning’ of a word, semantic communication focuses on a meaning to be conveyed through a signal. The essence of semantic communication is that a destination extracts the ‘meaning’ of information transmitted from a source. Semantic information may be successfully ‘interpreted’ through a common knowledge base 1150 between a source 1130 and a destination. Thus, even when a signal has an error, if an operation is performed according to meaning to be conveyed through the signal, communication is performed rightly. Accordingly, the approach of semantic communication needs to consider whether a task at a destination 1140 is performed as intent (e.g., classification or inference) contained in a signal (e.g., representation) transmitted from the source 1130. To this end, a transmitted signal should be generated in consideration of a task located at a destination.

As semantic information may significantly reduce energy and wireless resources that are necessary to transmit data, semantic information may be used for online meeting, augmented reality (AR), and virtual reality (VR). Accordingly, in recent years, studies are actively performed on a method for performing semantic encoding and decoding by using a deep neural network (DNN) for semantic communication. Specifically, there are ongoing studies that aim to expand the classic theory of information to semantic information theory (e.g., definition of semantic entropy, definition of semantic mutual information). In addition, there are also ongoing studies that define a loss function metric based on a wide meaning of semantic entropy and channel capacity and construct a semantic encoder and decoder using a DNN based on the defined metric.

Meanwhile, most studies for semantic information focus on extracting a feature including a whole feature sequence from an embedding vector with respect to a semantic encoder and focus on extracting a suitable output for a task purpose from a latent vector with respect to a semantic decoder. The semantic encoder may optimally perform compression by extracting a feature in consideration of every component of data. However, in this case, because the sizes of embedding vectors, which are inputs of the semantic encoder and the semantic decoder, become large, each DNN mode size becomes large (large-scale model). In addition, there is a disadvantage in that the importance of extracted features is difficult to select or a feature with an error is difficult to determine among extracted features.

In addition, a current semantic communication system performs channel coding by training through a DNN with inputs of semantic encoded feature vectors and using a loss function that maximizes mutual information between loss function transmission/reception sequences. Such a channel coding method cannot determine whether or not a receiver has rightly received a feature necessary to perform a task, because feature vectors are transmitted and received irrespective of importance of a feature component. Accordingly, the existing channel coding method for semantic communication does not include a mechanism of checking whether or not a receiver has rightly received a feature necessary to perform a task and of giving feedback, either. Considering what is described above, the present disclosure proposes a semantic channel coding method according to importance of feature vectors and a transmission/reception feedback method in semantic communication, by which ‘a feature necessary to achieve a task goal’ can be successfully transmitted and received.

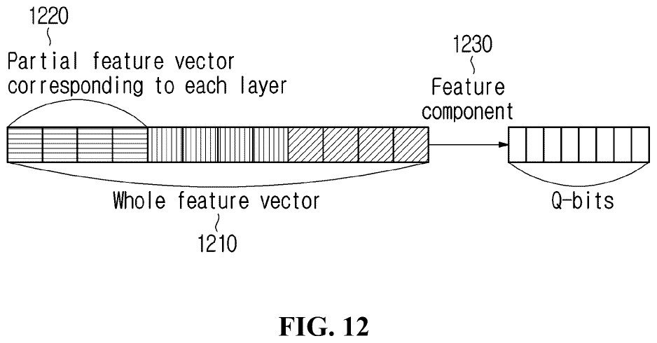

FIG. 12 illustrates an example of a feature vector according to an embodiment of the present disclosure. Referring to FIG. 12, it is possible to identify a whole feature vector 1210 including at least one partial feature vector 1220. The whole feature vector 1210 is a semantic source coded signal and may be a target of semantic channel coding. Each partial feature vector 1220 may corresponding to each layer. The whole feature vector 1210 may be extracted as a feature component 1230 in at least one Q-bit unit. A configuration of the feature component 1230 may be different according to a set value. As an example, the feature component 1230 may be bits corresponding to one partial feature vector. As another example, the feature component 1230 may be bits corresponding to a plurality of partial feature vectors.

As described above, semantic communication focuses on performing a task at a receiver according to an intention delivered by a transmitter. Accordingly, the receiver does not have to fully receive all the feature vectors. That is, communication may be rightly performed if as many feature vectors as necessary for the receiver to perform a task are accurately transmitted and received. Thus, the present disclosure proposes a channel coding method based on importance of a feature vector, by which features having a dominant impact on a task performed at a receiver may be accurately transmitted and received. According to the present disclosure, data transmission efficiency and communication performance may be improved because data is transmitted or retransmitted according to importance of a feature or a feature vector.

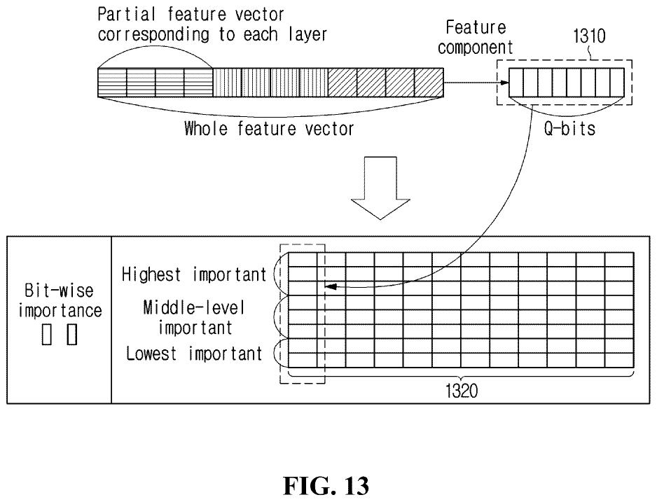

For channel coding for semantic communication, which is proposed in the present disclosure, selection of importance for feature vectors generated through semantic source coding should be performed beforehand. For importance selection methods, the present disclosure proposes a bit-wise importance selection method (hereinafter, ‘bit selection’ method), a feature-wise importance selection method (hereinafter, ‘feature selection’ method), and a subtask-wise importance selection method (hereinafter, ‘subtask selection’ method). In FIG. 13 to FIG. 15, methods for selecting importance of features will be described in detail. Herein, a feature vector may be segmented into partial feature vectors according to importance. Feature bits of a feature component may be segmented into partial feature bits according to importance. Feature vectors or feature bits, which are segmented according to importance, may be arranged according to an importance order-P.

FIG. 13 illustrates an example of bit selection according to an embodiment of the present disclosure. Bit selection is a method of selecting significant bits that have a dominant impact on a value of each of the feature component 1310. As an example, a feature component may include 4 bits. In this case, a first bit on the far left may indicate a code. A second bit, a third bit and a fourth bit may indicate the value of two squared, the value of two to the power of one and the value of two to the power of zero, respectively. As the first bit indicating a code has the most dominant impact on a value of a feature component, it may have high importance. In addition, the further to the right a bit is positioned, the less it affects the value of a feature component and thus may have low importance.

That is, according to the bit selection method, the further to the left a bit is positioned in a bit sequence of each feature component, it may be considered to have relatively higher importance. As an example, referring to FIG. 13, a bit block 1320 may be identified to have been configured such that the right side of the Q-bits feature component 1310 is positioned below. According to the bit selection method, in this case, the higher a bit is positioned in the bit block 1320, the higher importance it may have. The lower a bit is positioned, the lower importance it may have.

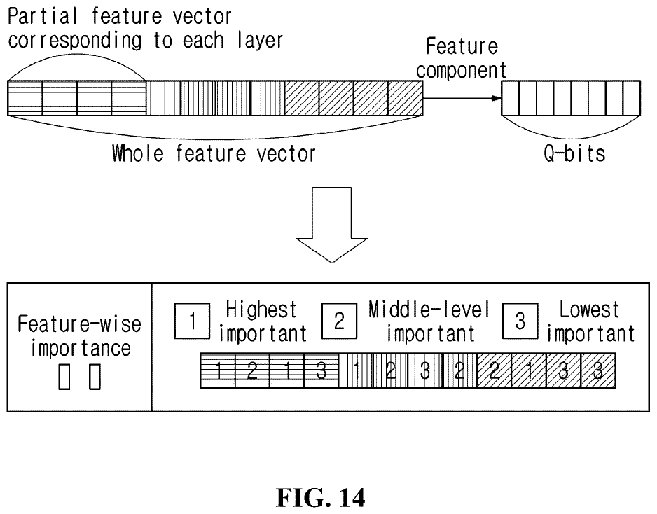

FIG. 14 illustrates an example of feature selection according to an embodiment of the present disclosure.

Referring to FIG. 14, it is possible to identify that features corresponding to a part marked as number 1 have high importance, features corresponding to a part marked as number 2 have middle importance, and features corresponding to a part marked as number 3 have low importance. Feature selection is a method of selecting importance of a feature component according to a degree of impact each feature component has on the operation of a subtask. Herein, since the feature component itself is not sufficient to identify the degree of impact on the operation of a subtask, feature selection may be performed using a trial error. As an example, an encoder may transmit only a feature component without redundancy to a decoder, without performing channel coding. The decoder may perform a task by using at least one received feature component and measure task operation accuracy. At this time, the decoder may measure accuracy of task operation according to whether or not there is an error in each received feature component. That is, according to the feature selection method, task operation accuracy of each feature component with an error may be represented in a histogram, a dominant feature component in task operation may be seen, and thus importance of feature components may be selected.

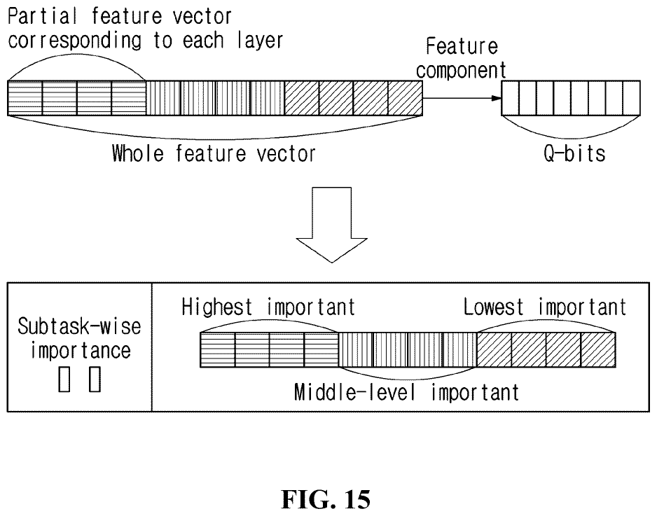

FIG. 15 illustrates an example of subtask selection according to an embodiment of the present disclosure. The subtask selection method may be applied to a situation in which an encoder and a decoder are affected by a result (output) of a previous subtask (e.g., semantic layered source coding situation). According to the subtask selection method, a feature or a feature vector corresponding to a preceding layer may be considered to have higher importance. In a semantic layered source coding environment, as a decoder performs decoding sequentially according to a layer index, an error occurring to a preceding layer increases a probability of error propagation. As an example, when a receiver (e.g., decoder) decodes a current layer, information decoded in a preceding layer may be used. Herein, if an error occurs in decoding of the preceding layer, an error may also occur thereafter so that the more preceding a layer is, the more important information the layer is considered to have. Accordingly, as features corresponding to low subtask indexes correspond preceding layers, vectors of the features may be selected as important information.

As described above, when importance of a feature vector is selected, channel coding may be performed according to an importance selection method. Herein, a transmitter and a receiver may have control information including the importance selection method and relevant information (e.g., a classification unit according to importance, an importance selection result) to perform channel coding. As an example, the transmitter and the receiver may have information on the importance selection method and the importance selection result through signaling indicating the control information (e.g., downlink control information, DCI). Table 2 below exemplifies an importance control indicator that is transmitted through control information. According to Table 2, an importance control indicator may indicate an importance selection method.

TABLE 2

| | Importance control | |
|---|---|---|
| Format | indicator (ICI) | Usage |
| Format 0_0 | 00 | Bit-wise importance selection |
| Format 0_1 | 01 | Subtask-wise importance |
| | | selection |
| Format 0_2 | 10 | Feature-wise importance |
| | | selection |

When an importance selection method is determined by an importance control indicator, an importance partition type may be determined by an indicator according to the determined importance selection method. An importance partition type may indicate a unit and a position for partitioning bits of a feature component according to importance. Table 3 below exemplifies bit-wise importance indication.

TABLE 3

| | Bit-wise | Important partition type |
|---|---|---|
| | importance selection | (high, middle, low) |
| Format | method indication | or (high, low) |
| Format 1_0 | 000 | (3, 3, 2) |
| Format 1_1 | 001 | (3, 2, 3) |
| Format 1_2 | 010 | (2, 4, 2) |
| Format 1_3 | 011 | (2, 3, 3) |
| Format 1_4 | 100 | (5, 3) |
| Format 1_5 | 101 | (4, 4) |
| Format 1_6 | 110 | (3, 5) |
| Format 1_7 | 111 | (2, 6) |

Referring to Table 3, when a bit selection method indicator is 000, an importance partition type is (3, 3, 2). As shown in FIG. 13, top 3 bits may have high importance, the next 3 bits may have middle importance, and the last 2 bits may have low importance.

A subtask selection method indicator and a feature selection method indicator may also be defined in a similar form to the bit selection method indicators. In the feature selection method, importance of each feature may be measured according to task operation accuracy based on whether or not there is an error in each feature, and a transmitter and a receiver may share a pattern that is defined for each indicator based on a measurement result. Meanwhile, Table 2 and Table 3 above are one embodiment for convenience of explanation, but the present disclosure is not limited thereto, and a method for indicating an importance selection method and a partition type of a feature component according to the importance selection method may be expanded in various ways.

Hereinafter, a method of performing channel coding for a feature vector will be described. A few notations will be defined beforehand. First, a semantic encoded feature component is assumed to be expressed by a Q-bit sequence. A semantic encoded feature vector with a length of

$$L ( L = {\sum }_{m = 1}^{M} {L}_{m} )$$

may be defined by Equation 1 below.

$$s = {[ {s}^{( m )} ]}_{m = 1}^{M} , {s}^{( m )} = {[ {s}_{n}^{( m )} ]}_{n = 1}^{{L}_{m}} \qquad [ Equation 1 ]$$

In Equation 1,

$${s}^{( m )} = {[ {s}_{n}^{( m )} ]}_{n = 1}^{{L}_{m}}$$

is a feature vector with a length of Lₘ corresponding to an m-th layer, and

$${S}_{n}^{( m )}$$

is an n-th entry of the feature vector corresponding to the m-th layer. Meanwhile, a binary notation for s,s^{(m)} is defined as s^{b},s^{b,(m)}, and a binary notation for

$${S}_{n}^{( m )}$$

is defined as

$${S}_{n}^{b , ( m )} .$$

A codeword for the semantic encoded feature vector of Equation 1 may be generated by using a linear block code according to an importance selection method. This will be described below with respect to encoder-side and decoder-side.

### Encoder-Side

### [Case 1: Bit-Wise Importance Selection]

In the bit selection method, channel coding may be performed based on importance of a bit-level sequence of a feature component. As an example, a bit sequence of a feature component

$$( {s}_{n}^{b , ( m )} = [ {s}_{n , 1}^{b , ( m )} , … , {s}_{n , Q}^{b , ( m )} ] )$$

may be partitioned into P according to importance, as shown in Equation 2 below.

$${s}_{n}^{b , ( m )} \to [ {s}_{n}^{b , ( 1 , m )} , … , {s}_{n}^{b , ( P , m )} ] \qquad [ Equation 2 ]$$

In Equation 2,

$${S}_{n}^{b , ( u , m )}$$

is

$${s}_{n}^{b , ( u , m )} = [ {s}_{n , {\sum }_{{u}^{′} = 1}^{u - 1} {L}_{u , m} + 1}^{b , ( m )} , … , {s}_{n , {\sum }_{{u}^{′} = 1}^{n - 1} {L}_{u , m}}^{b , ( m )} ] ,$$

and L_{n,m} is a size of a u-th bit partition in an m-th layer. Feature vectors collected according to each bit partition based on the bit selection method may be expressed by Equation 3 below.

$${s}^{b , p} = {[ {[ {s}_{n}^{b , ( p , m )} ]}_{n = 1}^{{L}_{m}} ]}_{m = 1}^{M} \qquad [ Equation 3 ]$$

In Equation 3, a partial codeword, which is generated by being encoded through a different channel coding code for each s^{b,p}, is expressed by Equation 4 below.

e^{b,p}=Gₚs^{b,p} [Equation 4]

In Equation 4, Gₚ is a generator matrix generated from Hₚ that is a parity check matrix, and P is an importance order. Accordingly, a code rate of each parity check matrix is expressed by Equation 5 below.

rₚ≤r_{q} for p<p [Equation 5]

As another example, a feature vector corresponding to a less importance bit partition according to a wireless resource situation may be transmitted through modulation without channel coding.

### Case 2: Feature-Wise Importance Selection

The feature selection method is a method of selecting a feature component that has a dominant impact in a whole feature vector. As an example, in the feature selection method, a feature vector sequence may be expressed by Equation 6 below.

$$s = {[ {s}_{n} ]}_{n = 1}^{L} {s}^{b} = {[ {s}_{n}^{b} ]}_{n = 1}^{LQ} \qquad [ Equation 6 ]$$

The feature selection method selects importance by transmitting and receiving a semantic encoded feature vector in an uncoded manner and identifying an impact of each feature component on task operation. Herein, a set of indexes (Iₚ) corresponding to an importance order-p may be expressed by Equation 7 below.

$${⋃}_{p = 1}^{r} {𝕀}_{p} = 𝕀 ( = \{ 1 , … , L \} ) \qquad [ Equation 7 ]$$

Here,

$${s}^{b , p} = {⌊ {s}_{n}^{b} ⌋}_{n ∈ {𝕝}_{p}^{b}} and {𝕝}_{p}^{b} = {⋃}_{i ∈ {𝕀}_{p}} \{ Q ( i - 1 ) + 1 , … , Qi \} .$$

Herein, if a codeword is generated by using the above-described generator matrix Gₚ, it may be expressed by Equation 4.

### [Case 3: Subtask-Wise Importance Selection]

In the subtask selection method, a layer index m may indicate importance of a feature vector. Herein, the number of bit partitions is P≤M When importance is selected according to each subtask, P=M, and when importance is considered to be identical for multiple subtasks, P<M. A case of selecting importance according to each subtask is expressed by Equation 8 below.

s^{h,p}=s^{b,(m)} for p=m [Equation 8]

Herein, if a codeword is generated by using the above-described generator matrix Gₚ, it may be expressed by Equation 4.

According to an embodiment of the present disclosure, a plurality of partial codewords may be generated through code block segmentation based on an importance order of feature vectors. Code block segmentation is an operation that performs channel coding by partitioning a feature vector to be transmitted according to importance. In case code block segmentation is applied, bit error rate performance may be reduced, but as whether or not decoding is successful may be identified for each of a plurality of partial codewords, whether or not to perform retransmission may be determined based on whether or not decoding is successful. In this case, among all the partial codewords, some codewords selected according to importance may be retransmitted so that efficiency of a wireless resource may be improved for the retransmission. That is, in a semantic communication system, as a receiver needs to receive codewords only to perform a task, whether or not to perform retransmission may be determined based on a predetermined criterion such as importance (majority) of a plurality of codewords in performing the task.

As an example, when transmitting a code block that is segmented by generating T partial code blocks, an encoder may partition a feature vector s_{b,p} into a plurality of sub-feature vectors

$${\{ {s}^{b , p , t} \}}_{t = i}^{T} .$$

A partial codeword, which is generated by using a generator matrix G̅ₚ of a parity check matrix H̅ₚ corresponding to each sub-feature vector, may be expressed by Equation 9 below.

c^{b,p,t}=G̅ₚs^{b,p,t} for t∈[1, . . . ,T] [Equation 9]

### Decoder-Side

A decoder may perform decoding based on a message-passing algorithm according to each partial codeword corresponding to an importance-order. Next, the decoder may perform a codeword checking operation to see whether partial codewords are correctly decoded. Herein, the decoder may perform a syndrome check. According to a linear block code characteristic, if decoded correctly, a decoded partial codeword ĉ_{b,p} satisfies Equation 10 below. A process of checking whether the decoded partial codeword ĉ_{b,p} satisfies Equation 10 is the syndrome check.

Hₚê^{b,p}=0 [Equation 10]

A check indicator value Cₚ for determining whether or not a decoding result of a codeword is right may be obtained through Equation 11 below.

$${c}_{p} = sum ( {H}_{p} {\hat{c}}^{b , p} ) \to \{ \begin{matrix}Success if {c}_{p} = 0 \\ Failure if {c}_{p} \neq 0\end{matrix} \qquad [ Equation 11 ]$$

Next, the decoder may transmit feedback on the decoding result. As an example, the decoder may transmit an ACK/NACK report for each partial codeword based on the decoding result of partial codewords. The decoder may transmit a message regarding whether a partial codeword corresponding to an importance order p is successfully decoded, based on a check indicator value. That is, for each partial feature vector, the decoder may transmit a message regarding whether or not decoding is successful. As an example, the message regarding whether or not decoding is successful may be ACK or NACK. If ACK is a response for every partial feature vector, a decoding procedure is terminated, and if the encoder receives at least one NACK, codeword retransmission of the encoder may be performed.

As an example, when the encoder receives NACK, the encoder may transmit additional redundancy for a partial feature vector corresponding to the received NACK. As another example, the encoder may retransmit a codeword for a partial feature vector corresponding to received NACK. The decoder may perform decoding again based on the retransmitted codeword and a preceding codeword that is received immediately before. As an example, the decoder may perform incremental redundancy approach or chase combining approach.

Meanwhile, if a code block is segmented into T partial code blocks, T check indicator values

$$( {c}_{p}^{t} = sum ( {H}_{p} {\hat{c}}^{b , p , t} ) )$$

may be obtained for an importance order-p. Based on the T check indicators, whether ACK/NACK is transmitted for a codeword corresponding to each importance order-p may be determined based on majority by using Equation 12 below.

$${\sum }_{t = 1}^{T} δ ( {c}_{p}^{t} ) \geq {ϵ}_{th} \qquad [ Equation 12 ]$$

$$δ ( a ) = 1 if a = 0 or 0 , otherwise$$

In Equation 12, Eth is a threshold that is a criterion for determining whether ACK/NACK is transmitted. As an example, if the threshold is not exceeded, retransmission may be performed only for sub-codewords (e.g., partial codewords) that are determined to fail in error correction.

Generally, the threshold is determined by the decoder, and relevant information is not delivered to the encoder side. However, in case resource efficiency improvement is required according to the situation of a network and a wireless resource, the decoder may report information on the threshold to the encoder. The encoder may determine a modulation setting and a channel coding code rate based on the information on the threshold. That is, the threshold may be used to infer a target quality of service (QoS).

According to an embodiment, in case additional redundancy is delivered for retransmission after initial transmission through code block segmentation, a single codeword, which is generated by performing channel coding on a single concatenated sub-feature vector merging partial feature vectors to be retransmitted, may be transmitted. This utilizes the characteristic that the slope of error rate performance increases along with the increase in the codeword length.

Accordingly, for initial transmission, an encoder may select and transmit reliable partial feature vectors (e.g., having high importance) to a decoder, and for retransmission, the encoder may merge and transmit partial feature vectors that are not successfully decoded. Thus, reliability of partial feature vectors may be secured, and further retransmission needs not be performed. In this case, it may be determined that information necessary to perform a task and reliability have been secured only by one retransmission.

That is, the encoder may merge partial feature vectors corresponding to an importance order-p corresponding to received NACK, perform channel coding on the partial feature vectors, and transmit a generated codeword to the decoder. The decoder may perform decoding for the received codeword based on a message-passing algorithm and determine, through a syndrome check, whether reception is successful. If there is an error of decoding based on a syndrome check result, hard decision may be performed by a feature soft value obtained by using a feature soft value obtained previous initial transmission and a weighted sum.

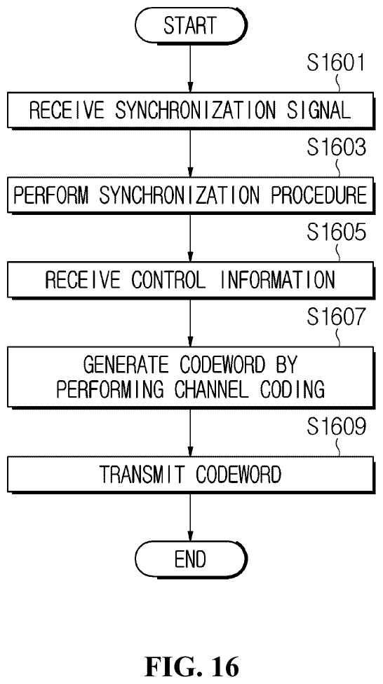

FIG. 16 illustrates an example of a channel coding procedure of a device according to an embodiment of the present disclosure.

Referring to FIG. 16, at step S1601, a first device may receive a synchronization signal from a second device. At step S1603, the first device may perform a synchronization procedure with the second device. At step S1605, the first device may receive control information from the second device. As an example, the control information may indicate a method for selecting importance of a feature vector and importance type information of each feature vector according to the importance selection method.

At step S1603, the first device may generate a codeword by performing channel coding for a bit-set based on the control information. The bit-set may correspond to a feature vector that is semantic source coded to perform semantic communication. The first device may determine importance of bits that are extracted from a feature vector according to the importance selection method determined based on the control information. In addition, the first device may generate a codeword by performing encoding according to importance that is determined according to each bit. The determined bit-wise importance is related to a degree of impact on task operation, and thus the importance may also be considered in retransmission. At step S1605, the first device may transmit the codeword to the second device.

As described above, a channel coding method based on an importance selection result of a feature vector, which is proposed by the present disclosure, may focus on transmission/reception of a feature vector that has a dominant impact on task operation, and thus communication performance may be improved. Furthermore, when retransmission is performed according to importance, resource efficiency may be enhanced.

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

1. A method comprising:
receiving a synchronization signal from a second device;
performing a synchronization procedure with the second device based on the synchronization signal;
receiving control information from the second device;
generating a codeword by performing channel coding for a bit-set based on the control information; and
transmitting the codeword to the second device,
wherein the bit-set corresponds to a semantic source coded feature vector for performing semantic communication, and
wherein the channel coding is performed based on importance of partial bit-sets included in the bit-set.

2. The method of claim 1, wherein the channel coding is performed by using channel coding codes different from each other according to the importance of the partial bit-sets.

3. The method of claim 1, wherein the importance of the partial bit-sets is determined according to positions of bits on a resource.

4. The method of claim 1, wherein the importance of the partial bit-sets is determined, in the second device, based on a result of a task operation that is performed by using the bit-set that is channel-coded not based on the importance of the partial bit-sets and is transmitted.

5. The method of claim 4, wherein the result of the task operation includes task operation accuracy information according to whether or not there is an error in each of the partial bit-sets.

6. The method of claim 1, wherein the importance of the partial bit-sets is determined based on an order of layers corresponding to the partial bit-sets.

7. The method of claim 1, wherein the control information includes a first indicator for indicating an importance selection method and a second indicator for indicating importance of each bit according to the importance selection method.

8. The method of claim 1, wherein the generating of the codeword comprises generating a plurality of partial codewords by using code block segmentation.

9. The method of claim 8, further comprising retransmitting at least one partial codeword based on importance of the bit-set and a feedback result.

10. The method of claim 9, wherein the feedback result is a response to a result of decoding that the second device performs for the codeword, and
wherein the response is determined according to each of the partial codewords.

11. The method of claim 11, wherein the feedback result is determined based on a syndrome check.

12. A method comprising:
transmitting a synchronization signal to a first device;
performing a synchronization procedure with the first device;
transmitting control information to the first device; and
receiving a codeword generated by channel coding that is performed for a bit-set based on the control information,
wherein the bit-set corresponds to a semantic source coded feature vector for performing semantic communication, and
wherein the channel coding is performed based on importance of partial bit-sets included in the bit-set.

13. A first device comprising:
a transceiver; and
a processor coupled with the transceiver,
wherein the processor is configured to:
receive a synchronization signal from a second device,
perform a synchronization procedure with the second device based on the synchronization signal,
receive control information from the second device,
generate a codeword by performing channel coding for a bit-set based on the control information, and
transmit the codeword to the second device,
wherein the bit-set corresponds to a semantic source coded feature vector for performing semantic communication, and
wherein the channel coding is performed based on importance of partial bit-sets included in the bit-set.

14-16. (canceled)

17. The first device of claim 13, wherein the channel coding is performed by using channel coding codes different from each other according to the importance of the partial bit-sets.

18. The first device of claim 13, wherein the importance of the partial bit-sets is determined according to positions of bits on a resource.

19. The first device of claim 13, wherein the importance of the partial bit-sets is determined, in the second device, based on a result of a task operation that is performed by using the bit-set that is channel-coded not based on the importance of the partial bit-sets and is transmitted.

20. The first device of claim 19, the result of the task operation includes task operation accuracy information according to whether or not there is an error in each of the partial bit-sets.

21. The first device of claim 13, wherein the importance of the partial bit-sets is determined based on an order of layers corresponding to the partial bit-sets.

22. The first device of claim 13, wherein the control information includes a first indicator for indicating an importance selection method and a second indicator for indicating importance of each bit according to the importance selection method.

23. The first device of claim 13, wherein the processor is further configured to generate a plurality of partial codewords by using code block segmentation.
